(19) United States
(12) Patent Application Publication
(10) Pub. No.: US 2009/0150964 A1
(43) Pub. Date: Jun. 11, 2009

(54) RELIABILITY DETECTOR FOR TPS DATA DECODING, PARTICULARLY IN DIGITAL TELEVISIONS

(76) Inventors: Yan Li, Shanghai (CN); Kun Wah Stanley Yip, Shanghai (CN)

Correspondence Address: Docket Clerk, P.O. Box 802432, Dallas, TX, 75380, US

(21) Appl. No.: 12/324,398

(22) Filed: Nov. 26, 2008

(30) Foreign Application Priority Data
Nov. 30, 2007 (CN) 200710195513.2

(51) Int. Cl. H04N 7/173; H04N 7/12

(52) U.S. Cl. 725/134; 375/240.25; 375/E07.027

(57) ABSTRACT

For digital TVs, transmission parameter signaling (TPS) data are normally required to be decoded and checked in every signal frame. In the Chinese DTV-T standard, these TPS data are transmitted over subcarriers in a contiguous frequency band of width 72 kHz, with the result that the SNR for these subcarriers may drop to a very low value due to lack of frequency diversity. The TPS data decoding error rate may rise significantly, severely impacting the DTV performance. A reliability detector is used to provide a reliability indication of the decoded TPS data. If this indication indicates that the decoded TPS data are likely to be incorrect, the receiver may discard the presently decoded TPS data and use the previously decoded ones (obtained when the reliability measure was high) or may take other appropriate actions. The reliability detector may include an SNR estimator, a comparator, and possibly storage. The SNR estimator estimates the SNR based on the present set of intermediate results obtained through the TPS data decoder and possibly sets of intermediate results obtained at earlier times.

### CROSS-REFERENCE TO RELATED APPLICATION(S) AND CLAIM OF PRIORITY

This application claims the benefit under 35 U.S.C. § 119(a) to a Chinese patent application filed in the State Intellectual Property Office of the People's Republic of China on Nov. 30, 2007 and assigned Serial No. 200710195513.2, the entire disclosure of which is hereby incorporated by reference.

### TECHNICAL FIELD OF THE INVENTION

The invention relates generally to digital television systems and, more particularly, to providing a reliability indicator at the receiver in a digital television system.

### BACKGROUND OF THE INVENTION

In August 2006, the standard for terrestrial digital television (DTV) broadcasting, hereinafter referred to as the DTV-T standard, was issued in China. The DTV-T standard contains a multi-carrier (MC) option and a single-carrier (SC) option. In the MC option, multiple subcarriers are used and data are transmitted on these subcarriers. The DTV-T standard states that 3780 subcarriers are used (generally regarded as the multicarrier option), of which 36 subcarriers are reserved for transmission parameter signaling (TPS) data.

A TPS data set is composed of seven bits of information. These seven bits can be partitioned into two sets, hereinafter referred to as the α-set and the β-set. The α-set consists of six bits indicating the modulation format used, the code rate used, the interleaving option used, etc. The β-set consists of only one bit, which is used to indicate which option (the MC option or the SC option) is used. The six β-set data are represented by a selected one of a set of 64 biorthogonal length-32 Walsh codes, which is then scrambled with a pseudo random noise (PN) sequence. The one β-set bit is duplicated four times. In total, the seven bits of TPS data are represented by a 36-bit sequence. Frequency-domain interleaving is then applied to the 36 bits in such a way that they are not transmitted on the subcarriers in a sequential order. These data are transmitted on subcarriers with subcarrier numbers 0 to 17 and 3762 to 3779. That is, the 36 subcarriers transmitting the TPS data are within the band of subcarriers from 0 to 17 and from 3762 to 3779. Due to the cyclic property of the Discrete Fourier Transform (DFT), these 36 subcarriers essentially fall into a contiguous band of width 36×2 kHz=72 kHz.

If the band that carries the TPS data is under deep fading, the subcarrier symbol energy-to-noise ratio may drop to a very low value. The TPS data decoding error rate for the α-set may be significantly increased. If the receiver finds that the α-set data are not consistent with the expected ones, it may discard the signal frame. Since the DTV-T standard employs very deep interleaving, a mistaken discard of one signal frame can affect the data of many signal frames, and may even lead to a loss of several image frames in the TV video. Therefore, the consequence of a significant increase in the TPS data decoding error rate caused by deep fading is severe.

### SUMMARY OF THE INVENTION

A reliability indicator is provided for TPS data that are decoded at the receiver in a digital television system. This indicator indicates whether the decoded α-set TPS data are likely to be incorrect. If that is the case, the receiver may discard the presently decoded α-set data and use the previously decoded ones (obtained when the reliability measure was high) or may take other appropriate actions. Note that if the subcarriers carrying TPS data are not in deep fade, the reliability indicator is likely to indicate that the decoded α-set data are reliable, so that the receiver can distinguish the α-set data if the currently received signal frame is for the desired DTV service or for other services. In the case where the subcarriers are in deep fade and the reliability indicator gives an indication that the decoded α-set data are likely to be erroneous, the receiver can reduce the likelihood of a mistaken discard of a signal frame. The ability of the receiver to distinguish different services by means of the α-set data is sacrificed, but distinguishing different services based on possibly erroneous α-set TPS data is always problematic. Using the present reliability indicator therefore improves viewing quality of TV programs if the TV signal contains only one service (TV program broadcasting).

Other features and advantages will be understood upon reading and understanding the detailed description of exemplary embodiments, found herein below, in conjunction with reference to the drawings, a brief description of which is provided below.

### BRIEF DESCRIPTION OF THE DRAWINGS

FIG. 1 is a plot of error probability in α-set TPS data decoding on an additive white Gaussian noise (AWGN) channel versus the subcarrier symbol energy-to-noise ratio.

FIG. 2 is a block diagram of a TPS data decoder model.

FIG. 3 is a block diagram of a TPS data reliability detector.

There follows a more detailed description of the present invention. Those skilled in the art will realize that the following detailed description is illustrative only and is not intended to be in any way limiting. Other embodiments of the present invention will readily suggest themselves to such skilled persons having the benefit of this disclosure. Reference will now be made in detail to embodiments of the present invention as illustrated in the accompanying drawings. The same reference indicators will be used throughout the drawings and the following detailed description to refer to the same or like parts.

### DETAILED DESCRIPTION OF EXEMPLARY EMBODIMENTS

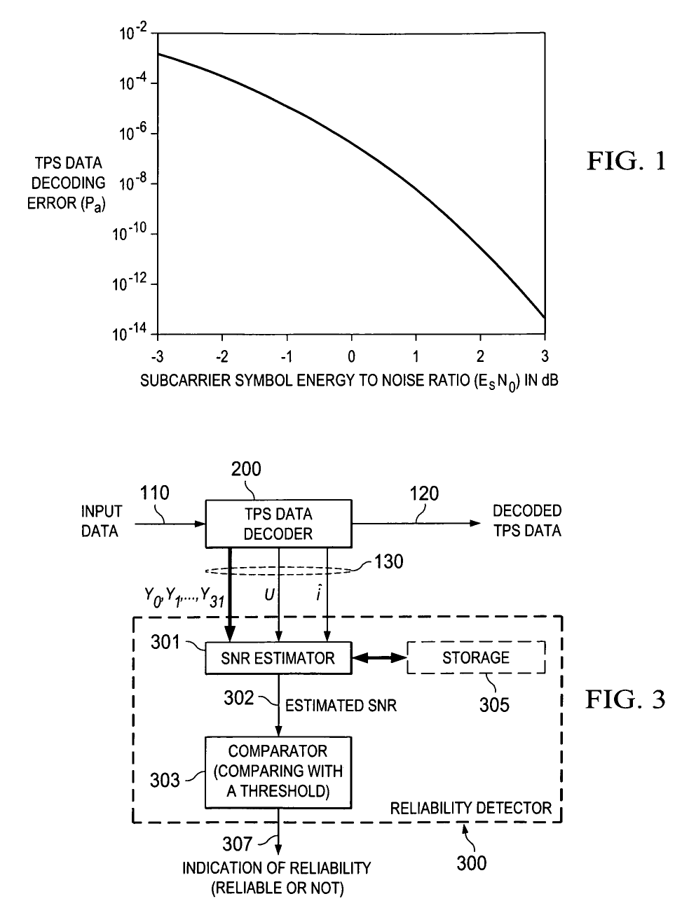

FIG. 1 plots the error probability in decoding the six bits in the α-set, P_{α}, against the subcarrier symbol energy to noise ratio, Eₛ/N₀, for AWGN channels. It is apparent that Eₛ/N₀ equal to about 2.2 dB gives a P_{α} value of 10⁻¹¹, corresponding to a commonly used view-quality criterion of one error event every one hour of TV viewing. Although the required Eₛ/N₀ value is very low, the received Eₛ/N₀ value can drop significantly when the received signal is in deep fade. A commonly used technique to prevent this significant drop in Eₛ/N₀ is to use frequency diversity. This diversity can be utilized if the frequency band used to transmit the signal is wider than the coherence bandwidth of the channel. Although a DTV-T signal occupies a bandwidth of about 8 MHz, the subcarriers that carry the TPS data are clustered within a bandwidth of only 72 kHz. Utilizing frequency diversity is not always possible.

The receiver may not need to check the bit in the β-set for each signal frame because, in practice, the broadcaster does not change the transmission option used during broadcasting. (A signal frame is the basic unit for carrying data.) However, the α-set bits are normally required to be decoded and checked for every signal frame. This is because some α-set bits are reserved for future use, and this feature enables TV broadcasters to embed other services into TV signals. If the band that carries the TPS data is under deep fading, Eₛ/N₀ may drop to a very low value. The TPS data decoding error rate for the α-set may be significantly increased. If the receiver finds that the α-set data are not consistent with the expected ones, it may discard the signal frame. Since the DTV-T standard employs very deep interleaving, a mistaken discard of one signal frame can affect the data of many signal frames, and may even lead to a loss of several image frames in the TV video. Therefore, the consequence of a significant increase in the TPS data decoding error rate caused by deep fading is severe.

Let b₀b₁b₂b₃b₄b₅ denote the α-set TPS data vector, where bᵢε{+1,−1}, i=0, 1, 2, 3, 4, 5. First, b₀b₁b₂b₃b₄ is mapped to a length-32 Walsh sequence s₀s₁ . . . s_{M-1} where M=32 is the length of the Walsh sequence, and sₖε{+1,−1}, k=0, 1, . . . , M−1. The Walsh chips are then scrambled to give:

s₀c₀, s₁c₁, . . . , s_{M-1}c_{M-1},

where cₖε{+1,−1} is the kth chip of the PN sequence specified in the DTV-T standard. The remaining bit b₅ is used to modulate the scrambled Walsh sequence, giving:

b₅s₀c₀, b₅s₁c₁, . . . , b₅s_{M-1}c_{M-1}.

The kth chip is transmitted on the ξ(k)th subcarrier where ξ(·) is the interleaving function. Consider that an Orthogonal Frequency Division Multiplexing (OFDM) symbol carrying only α-set TPS data is transmitted. The complex envelope of the transmitted signal, s(t), is given by:

$$s ( t ) = \sqrt{2 {P}_{s}} {\sum }_{k = 0}^{M - 1} {\sum }_{n = 0}^{N - 1} {b}_{5} {s}_{k} {c}_{k} {e}^{j 2 π n ξ ( k ) / N} ψ ( t - {nT}_{c} ) , \qquad ( 1 )$$

where N=3780 is the total number of subcarriers used in DTV-T systems, Pₛ is the per-subcarrier transmitted power, 1/T_{c} is the chip rate (equal to the sampling rate, i.e., 7.56M samples/s), and ψ(t) is the square-root raised cosine pulse satisfying ∫_{-∞}^{∞}|ψ(t)|²dt=T_{c}. Note that the OFDM symbol duration, Tₛ, is given by Tₛ=NT_{c}.

The complex envelope of the received signal is given by:

$$r ( t ) = n ( t ) + \sqrt{2 {P}_{s}} {\sum }_{k = 0}^{M - 1} {\sum }_{n = 0}^{N - 1} {b}_{5} {s}_{k} {c}_{k} {g}_{ξ ( k )} {e}^{j 2 π n ξ ( k ) / N} ψ ( t - {nT}_{c} ) , \qquad ( 2 )$$

where gᵢ is the complex-valued channel gain of the ith subcarrier, and n(t) is the baseband-equivalent AWGN satisfying ½E{n(t)n*(t+Δt)}=N₀δ(Δt), with N₀ being the one-sided noise power spectral density. For the present description, it is sufficient to assume that the channel gains are the same for the subcarriers on which TPS data are transmitted, so that gᵢ is independent of i and G=|gᵢ|². The data transmitted on the ξ(k)th subcarrier is extracted by first performing matched filtering (under the assumption of perfect timing and frequency synchronization) followed by a DFT operation. Let

Rₘ=∫_{-∞}^{∞}r(t)ψ*(t−mT_{c})dt for 0≦m≦N−1. (3)

Substituting (2) into (3) yields:

$${R}_{m} = {\tilde{N}}_{m} + \sqrt{2 {P}_{s}} {T}_{c} {\sum }_{k = 0}^{M - 1} {b}_{5} {s}_{k} {c}_{k} {g}_{ξ ( k )} {e}^{j 2 π m ξ ( k ) / N} , \qquad ( 4 )$$

where Ñₘ=∫_{-∞}^{∞}n(t)ψ*(t−mT_{c})dt follows a complex Gaussian distribution with zero mean and variance 2N₀T_{c}. Then compute

$${γ}_{k} = {\sum }_{m = 0}^{N - 1} {R}_{m} {e}^{- j 2 π m ζ ( k ) / N} for k = 0 , 1 , … , M - 1. \qquad ( 5 )$$

Let Eₛ=PₛTₛ be the energy of a symbol transmitted on a subcarrier. Substituting (4) into (5), one obtains:

γₖ=Nₖ+\sqrt{2Pₛ}Tₛb₅sₖcₖg_{ξ(k)}, (6)

where Nₖ is a zero-mean complex Gaussian random variable with variance 2N₀Tₛ.

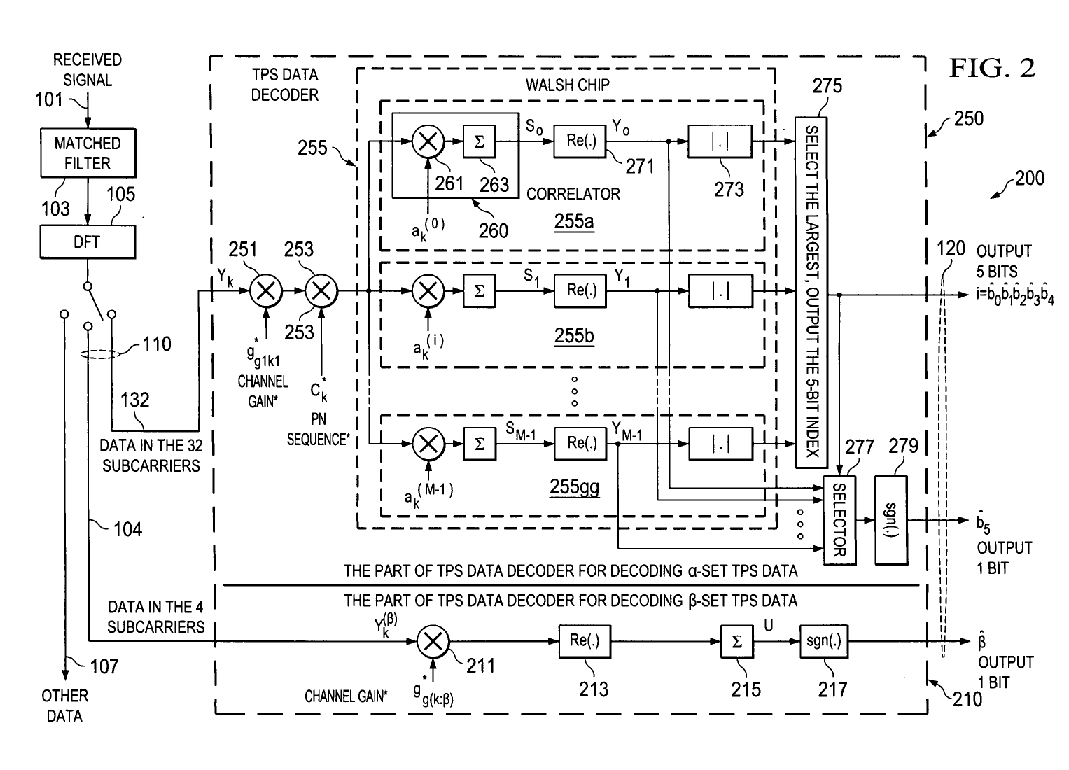

A decoder model used to process γₖ, k=0, 1, . . . , M−1, is depicted in FIG. 2. The TPS data decoder receives input data 110 and decodes the input data to produce decoded TPS data 120. The received signal 101 is first processed by a matched filter 103. The four subcarriers 104 that carry the β-set TPS data are then extracted by performing a DFT operation 105 on the matched filter outputs and applied to first decoder part 210 of a TPS data decoder 200. The 32 subcarriers 132 that carry the α-set TPS data are also extracted by the DFT operation 105 and applied to a second decoder part 250. Other data 107 of other subcarriers is routed to another portion (not shown) of the receiver.

Within the first decoder part 210, the data of each of the four subcarriers is multiplied in a multiplier 211 by a respective conjugate channel gain factor. Respective real portions of the resulting signals are taken in block 213, and resulting real values are summed in an adder 215 to obtain a value U. The sign function (block 217) is applied to U to obtain the output bit \hat{β}.

Within the second decoder part 250, the data of each of the 32 subcarriers is multiplied in a multiplier 251 by a respective conjugate channel gain factor and multiplied again in a subsequent multiplier 253 by a respective conjugate PN sequence value. The resulting data for each of the respective 32 subcarriers is then processed in a corresponding branch of a circuit 255 having 32 identical branches 255ₐ-255_{gg}, of which only the branch 255ₐ will be described in detail.

In each of the respective branches, a correlation is performed between the subcarrier data and a respective one of the 32 possible Walsh sequences. In the branch 255ₐ, a correlator 260 is formed by a multiplier 261, to which Walsh chips of the corresponding Walsh sequence are applied, and an adder 263. The correlator 260 produces a correlation result S₀, of which the real portion is taken in block 271 to form a value Y₀. The absolute value of Y₀ is taken in block 273.

In a remaining portion of the second decoder part 250, block 275 selects the Y value having the largest absolute value and outputs the corresponding 5-bit index as \hat{b}₀\hat{b}₁\hat{b}₂\hat{b}₃\hat{b}₄. The index is applied to a selector 277, which selects the corresponding Y value. The sign function (block 279) is applied to the selected Y value to obtain the output bit \hat{b}₅.

More particularly, let a₀⁽ⁱ⁾a₁⁽ⁱ⁾ . . . a_{M-1}⁽ⁱ⁾, where aₖ⁽ⁱ⁾ε{+1,−1}, k=0, 1, . . . , M−1, denote the ith sequence from the set of length-M Walsh sequences. Assume that a perfect knowledge of channel estimation is available. Compute the correlation results

$${S}_{i} = {\sum }_{k = 0}^{M - 1} {γ}_{k} {g}_{ξ ( k )}^{*} {c}_{k}^{*} {a}_{k}^{{( i )}^{*}} for i = 0 , 1 , … , M - 1. \qquad ( 7 )$$

Substituting (6) into (7) gives:

$${S}_{i} = {\sum }_{k = 0}^{M - 1} {N}_{k} {g}_{ξ ( k )}^{*} {c}_{k}^{*} {a}_{k}^{{( i )}^{*}} + \sqrt{2 {P}_{s}} {T}_{s} {b}_{5} G {\sum }_{k = 0}^{M - 1} {s}_{k} {a}_{k}^{{( i )}^{*}} . \qquad ( 8 )$$

Note that the noise term in Sᵢ is complex-Gaussian distributed with zero mean and variance 2N₀TₛMG, and that the noise terms of Sᵢ and S_{i′} are statistically uncorrelated if i≠i′. Denote the estimated b₀b₁b₂b₃b₄ as î=\hat{b}₀\hat{b}₁\hat{b}₂\hat{b}₃\hat{b}₄ and the estimated b₅ as \hat{b}₅. Let

Yᵢ=Re(Sᵢ), i=0, 1, . . . , M−1. (9)

### Then

$$\begin{matrix}\hat{i} = {argmax}_{i ∈ \{ 0 , 1 , … , M - 1 \}} \vert {Y}_{i} \vert \\ and & ( 10 ) \\ {\hat{b}}_{5} = sgn ( {Y}_{\hat{i}} ) . & ( 11 )\end{matrix}$$

Let β be the TPS bit in the β-set, where ββ{+1,−1}. This bit is duplicated four times for transmission. Let M_{B} be the number of subcarriers for transmitting the P-set data, i.e., M_{B}=4.

Referring to (6), one can see that the receiver obtains:

γₖ^{(β)}=Nₖ^{(β)}+\sqrt{2Pₛ}Tₛβ·g_{ξ(k;β)}, k0, 1, . . . , M_{β}−1, (12)

where γₖ^{(β)} is the output after the DFT operation, Nₖ^{(β)} is a zero-mean complex Gaussian random variable with variance 2N₀Tₛ, and ξ(k;β) is the frequency-interleaving function indicating the subcarrier number for transmitting the kth data. Note that gᵢ is the channel gain for the ith subcarrier and, again, G=|gᵢ|². The estimated β, denoted as \hat{β}, is given by:

$$\begin{matrix}\hat{β} = sgn ( U ) , \\ where & ( 13 ) \\ U = {\sum }_{k = 0}^{{M}_{B} - 1} Re ( {γ}_{k}^{( β )} {g}_{ξ ( k ; β )}^{*} ) . & ( 14 )\end{matrix}$$

It can be shown that the α-set TPS data decoding error rate is determined by G(Eₛ/N₀). It follows that if the receiver has a knowledge of G(Eₛ/N₀), the reliability of the decoded α-set TPS data can be determined. Estimating this figure (or a more general signal-to-noise ratio (SNR)) at the receiver is the main task to be performed.

From (8), it is apparent that

E(Yᵢ|sₖ≡aₖ⁽ⁱ⁾, k=0, 1, . . . , M−1)=\sqrt{2Pₛ}Tₛb₅MG (15)

and

var(Yᵢ|sₖ≠aₖ⁽ⁱ⁾, k=0, 1, . . . , M−1)=N₀TₛMG, (16)

where the expectation and variance are ensemble-averaged values. It follows that

$$G \frac{{E}_{s}}{{N}_{0}} = \frac{1}{2 M} \cdot \frac{{[ E ( {Y}_{i} \vert {s}_{k} ≡ {a}_{k}^{( i )} , k = 0 , 1 , … , M - 1 ) ]}^{2}}{var ( {Y}_{i} \vert {s}_{k} \neq {a}_{k}^{( i )} , k = 0 , 1 , … , M - 1 )} . \qquad ( 17 )$$

Alternatively, G(Eₛ/N₀) can be obtained by observing U. From (12) and (14), it is noticed that

$$\begin{matrix}E ( U ) = \sqrt{2 {P}_{s}} {T}_{s} β {GM}_{β} \\ and & ( 18 ) \\ var ( U ) = {M}_{β} {GN}_{0} {T}_{s} . \\ Hence . & ( 19 ) \\ G \frac{{E}_{s}}{{N}_{0}} = \frac{1}{2 {M}_{β}} \cdot \frac{{[ E ( U ) ]}^{2}}{var ( U )} . & ( 20 )\end{matrix}$$

From (17) and (20), it is apparent that one may estimate G(Eₛ/N₀) based on the following 33 intermediate results: Yᵢ, Yᵢ for i≠i′ (31 values), and U. Furthermore, the estimation can be made more accurately by using more than one set of intermediate results, i.e., by including sets obtained at previous time instants. Let N_{ob} be the number of sets of intermediate results used to compute the estimated SNR value. That is, N_{ob}−1 sets of previous ones are involved. For convenience, let Yᵢ(n) be the ith real-valued correlation value (Yᵢ) generated at time n, wherein i=0, 1, . . . , M−1, and n=0, 1, . . . , N_{ob}−1; let î(n) be the index indicating the correlation result having the largest magnitude among all correlation values obtained at time n; and let U(n) be the value of U obtained at time n. Without loss of generality, it is assumed that the present set of intermediate results is obtained at time N_{ob}−1. Based on the N_{ob} sets of intermediate results, compute

$$\begin{matrix}Ξ = \frac{1}{2 {N}_{ob}} {\sum }_{n = 0}^{{N}_{ob} - 1} [ \vert {Y}_{\hat{i} ( n )} ( n ) \vert + \frac{M}{{M}_{β}} \vert U ( n ) \vert ] \\ and & ( 21 ) \\ Ω = \frac{1}{{N}_{ob} ( M - 1 )} {\sum }_{n = 0}^{{N}_{ob} - 1} {\sum }_{m = 0 , m \neq \hat{i} ( n )}^{M - 1} {[ {Y}_{m} ( n ) ]}^{2} . & ( 22 )\end{matrix}$$

In the two expressions, Ξ and Ω are estimates of |E(Yᵢ|sₖ≡aₖ⁽ⁱ⁾, k=0, 1, . . . , M−1)| and var(Yᵢ|sₖ≠aₖ⁽ⁱ⁾, k=0, 1, . . . , M−1), respectively. The information provided by U is used to help improve the accuracy in the computation of Ξ and, therefore, is not reused again in the computation of Ω in (22). In the derivation of (21), use is made of the relationship \hat{b}₅Y_{î}=|Y_{î}|. That is, the removal of the effect of \hat{b}₅ from Y_{î} is equivalent to computing the absolute value of Y_{î}. Similarly, the relationship of \hat{β}U=|U| is employed in deriving (21). The estimated G(Eₛ/N₀) value is then computed by:

$$Estimated G \frac{{E}_{s}}{{N}_{0}} = \frac{1}{2 M} \cdot \frac{{Ξ}^{2}}{Ω} . \qquad ( 23 )$$

FIG. 3 is a schematic diagram of a reliability detector 300. This reliability detector comprises an SNR estimator 301, a comparator 303, and a possible storage means 305. The SNR estimator 301 receives the values î, U, and Y₀, Y₁, . . . , Y₃₁ and uses these values 130 to estimate the value of SNR (302) for the received TPS data. The comparator 303 compares the estimated SNR with a threshold value to produce a reliability indicator 307. Storage 305 may optionally be provided to store one or more sets of previous intermediate data to be used together with a current set of intermediate data in estimating the SNR.

More particularly, the SNR estimator estimates the value of SNR for the received TPS data, with N_{ob} sets of intermediate results (N_{ob}≧1) obtained at the present time and at N_{ob}−1 earlier time instants, wherein each set comprises: î; Yᵢ, i=0, 1, . . . , M−1; and U. That is, each set of intermediate results comprises: from the α-set TPS data decoder, (a) the 32 real-valued correlation results after correlating the sequence of 32 demodulated data carried in the desired subcarriers with the 32 scrambled Walsh sequences and (b) the index indicating the correlation result that has the largest magnitude among all correlation results; and from the β-set TPS data decoder, the result after summing the contribution from individual subcarriers.

In the above description, the expression G(Eₛ/N₀) is meaningful only if the channel for TPS data is frequency-nonselective. The SNR estimator is intended to work not only for frequency-nonselective channels but also for a general radio channel. In the latter case, the estimated SNR value may be a generic SNR value, not indicating a value specifically targeted to be an estimate of G(Eₛ/N₀).

The output of the SNR estimator is produced at a rate equal to the rate of the incoming sets of intermediate results. The estimation of SNR can be based on the presently obtained set of intermediate results, or include previous ones. If it is desired to compute the estimated SNR value based on one or more sets of previous intermediate results, a storage means is required to store these previous sets. After the estimated SNR is obtained, this value is fed to the comparator to compare with a threshold value. If the estimated SNR exceeds the threshold value, the receiver can consider that the decoded TPS data are reliable; otherwise, they are considered unreliable.

The operation of the SNR estimator is detailed as follows. Values of Ξ and Ω are computed by (21) and (22), respectively, based on the N_{ob} sets of intermediate results. Then the SNR is estimated by:

$$Estimated S N R = \frac{1}{2 M} \cdot \frac{{Ξ}^{2}}{Ω} . \qquad ( 24 )$$

After the computation of the estimated SNR value, the storage means is updated to store the set of intermediate results obtained at time N_{ob}−1 and discard the set obtained at time 0, in order to enable estimation of the SNR value for the next time instant.

It is noted that instead of storing Yₘ(n), n=0, 1, . . . , N_{ob}−2 and m=0, 1, . . . , M−1, in the storage means, the receiver can save some storage space by storing only |Y_{î(n)}(n)| and Σ_{m=0,m≠î(n)}^{M-1}[Yₘ(n)]², n=0, 1, . . . , N_{ob}−2.

Although embodiments of the present invention have been described in detail, it should be understood that various changes, substitutions and alternations can be made without departing from the spirit and scope of the inventions as defined by the appended claims.

What is claimed is:

1. A method of receiving a broadcast transmission comprising:
receiving transmission parameter signaling data;
decoding the transmission parameter signaling data to obtain decoded transmission parameters;
forming a measure of reliability of the decoded transmission parameters using the transmission parameter signaling data; and
determining reliability of the decoded transmission parameters using the measure of reliability.

2. The method of claim 1, wherein the measure of reliability is a measure of signal-to-noise ratio of the transmission parameter signaling data.

3. The method of claim 2, wherein determining reliability comprises comparing the measure of signal-to-noise ratio to a threshold.

4. The method of claim 3, comprising:
receiving and storing a first transmission parameter signaling data;
receiving and storing an n-th transmission parameter signaling data; and
using the first through the n-th transmission parameter signaling data to form the measure of reliability.

5. The method of claim 3, wherein the broadcast transmission is a multicarrier-based broadcast transmission in which a first set of transmission parameters is signaled using a first set of sub-carriers and a second set of at least one transmission parameter is signaled using a second set of sub-carriers.

6. The method of claim 5, comprising receiving a first data transmitted using the first set of sub-carriers and a second data transmitted using the second set of sub-carriers.

7. The method of claim 6, wherein forming a measure of reliability comprises:
correlating each of a plurality of code sequences with the first data to obtain a plurality of correlation results, and determining a largest correlation result;
forming a first quantity using the first data and the largest correlation result;
forming a second quantity using a plurality of the correlation results; and
dividing or multiplying the first quantity and the second quantity to obtain the measure of signal-to-noise ratio.

8. The method of claim 7, wherein the second quantity is formed as a sum of squares of the correlation results.

9. The method of claim 8, comprising dividing the first quantity by the second quantity.

10. The method of claim 7, wherein forming the first quantity comprises summing the data values of the first data to obtain a sum of data values.

11. The method of claim 10, wherein forming the first quantity comprises forming a sum of a quantity derived from a magnitude of the largest correlation result and a quantity derived from a magnitude of the sum of data values.

12. An apparatus for receiving a broadcast transmission comprising:
means for receiving transmission parameter signaling data transmitted using a plurality of sub-carriers;
means for decoding the transmission parameter signaling data to obtain decoded transmission parameters;
means for forming a measure of reliability of the decoded transmission parameters using the transmission parameter signaling data; and
means for determining reliability of the decoded transmission parameters using the measure of reliability.

13. The apparatus of claim 12, wherein the measure of reliability is a measure of signal-to-noise ratio of the received transmission parameter signaling data.

14. The apparatus of claim 13, wherein the means for determining reliability comprises means for comparing the measure of signal-to-noise ratio to a threshold.

15. The apparatus of claim 14, comprising:
means for receiving and storing a first transmission parameter signaling data; and
means for receiving and storing an n-th transmission parameter signaling data;
wherein the first through the n-th transmission parameter signaling data are used to form the measure of reliability.

16. The apparatus of claim 14, wherein the broadcast transmission is a multicarrier-based broadcast transmission in which a first set of transmission parameters is signaled using a first set of sub-carriers and a second set of at least one transmission parameter is signaled using a second set of sub-carriers.

17. The apparatus of claim 16, comprising receiving a first data transmitted using the first set of sub-carriers and a second data transmitted using the second set of sub-carriers.

18. The apparatus of claim 17, wherein the means for forming a measure of reliability comprises:
means for correlating each of a plurality of code sequences with the first data to obtain a plurality of correlation results, and determining a largest correlation result;
means for forming a first quantity using the first data and the largest correlation result;
means for forming a second quantity using a plurality of the correlation results; and
means for dividing or multiplying the first quantity and the second quantity to obtain the measure of signal-to-noise ratio.

19. The apparatus of claim 18, wherein the second quantity is formed as a sum of squares of the correlation results.

20. The apparatus of claim 19, comprising means for dividing the first quantity by the second quantity.

21. The apparatus of claim 18, wherein the means for forming the first quantity comprises means for summing the data values of the first data to obtain a sum of data values.

22. The apparatus of claim 21, wherein the means for forming the first quantity comprises means for forming a sum of a quantity derived from a magnitude of the largest correlation result and a quantity derived from a magnitude of the sum of data values.

23. An apparatus for receiving a broadcast transmission comprising:
a decoder configured to receive transmission parameter signaling data transmitted using a plurality of sub-carriers and decode the transmission parameter signaling data to obtain decoded transmission parameters;
a correlator configured to form a measure of reliability of the decoded transmission parameters using the transmission parameter signaling data; and
a detector configured to determine reliability of the decoded transmission parameters using the measure of reliability.

24. The apparatus of claim 23, wherein the measure of reliability is a measure of signal-to-noise ratio of the received transmission parameter signaling data.

25. The apparatus of claim 24, wherein the detector comprises a comparator configured to compare the measure of signal-to-noise ratio to a threshold.

26. The apparatus of claim 25, comprising:
a first storage means configured to receive and store a first transmission parameter signaling data; and
a second storage means configured to receive and store a n-th transmission parameter signaling data;
wherein the first through the n-th transmission parameter signaling data are used to form the measure of reliability.

27. The apparatus of claim 25, wherein the broadcast transmission is a multicarrier-based broadcast transmission in which a first set of transmission parameters is signaled using a first set of sub-carriers and a second set of at least one transmission parameter is signaled using a second set of sub-carriers.

28. The apparatus of claim 27, comprising receiving a first data transmitted using the first set of sub-carriers and a second data transmitted using the second set of sub-carriers.

29. The apparatus of claim 28, wherein the correlator comprises:
a selector configured to correlate each of a plurality of code sequences with the first data to obtain a plurality of correlation results, and to determine a largest correlation result;
a first quantity component configured to form a first quantity using the first data and the largest correlation result;
a second quantity component configured to form a second quantity using a plurality of the correlation results; and
a computation component configured to divide or multiply the first quantity and the second quantity to obtain the measure of signal-to-noise ratio.

30. The apparatus of claim 29, wherein the second quantity is formed as a sum of squares of the correlation results.

31. The apparatus of claim 30, comprising a dividing component configured to divide the first quantity by the second quantity.

32. The apparatus of claim 29, wherein the means for forming the first quantity comprises means for summing the data values of the first data to obtain a sum of data values.

33. The apparatus of claim 32, wherein the first quantity component comprises a summation component configured to form a sum of a quantity derived from a magnitude of the largest correlation result and a quantity derived from a magnitude of the sum of data values.
